(19) United States
(12) Patent Application Publication
(10) Pub. No.: US 2009/0177807 A1
(43) Pub. Date: Jul. 9, 2009

(54) RESET METHOD FOR APPLICATION SPECIFIC INTEGRATED CIRCUITS (ASIC)

(75) Inventor: Kelvin Wong, Eastleigh (GB)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/968,728

(22) Filed: Jan. 3, 2008

(51) Int. Cl. G06F 13/10

(52) U.S. Cl. 710/18

(57) ABSTRACT

A method and arrangement for avoiding an operative deadlock in an Application Specific Integrated Circuit (ASIC) when it is only partially reset, such as when only some parts of the ASIC are reset whereas others are left to remain active.

### BACKGROUND OF THE INVENTION

1. Field of the Invention

The present invention relates to a method and arrangement for avoiding an operative deadlock in an Application Specific Integrated Circuit (ASIC) when it is only partially reset, i.e., when only some parts of the ASIC are reset whereas others are left to remain active.

ASICs are typically made up of components, also known as islands, connected together using an internal interconnect protocol. For example, a shared bus architecture or a point-to-point topology or the protocol is described in “VLSI Chip Macro Interface”, Gray, et al., U.S. Pat. No. 6,467,001. Some of these islands or components implement external interfaces so that the ASIC can communicate with other devices within a host computer system it is embedded in. Hereinbelow, there is illustrated a manner in which an ASIC might be connected within such a system; whereby the system communicates with the ASIC using a protocol that may be an industry-wide standard (such as PCI-Express) or it may be a bespoke protocol. A processor may be attached to the ASIC (via the same or different protocol standard) and may be used to direct the ASICs operations.

A so-called “Host Protocol” island implements the interface, as shown in FIG. 1, which allows the ASIC to communicate with the host system. A separate island, a so-called “Processor Protocol” island, similarly allows communication with the processor. There may be other protocol islands, which allow communication with external peripheral devices that are ancillary attached to the ASIC. The ASIC may also possess other internal islands, which implement diverse functions, for instance, such as a DMA engine or a data encryption island. All islands are connected via an interconnect allowing data transfer between islands, and wherein each island has an interconnect port. When an island wishes to transfer data to or from another island, a connection is made between the interconnect ports of the two islands, and whereby the connection is then terminated once the data transfer is complete. Depending upon the exact architecture of the ASIC, an island may possess more than one interconnect port, each being capable of establishing a connection to a different island. Thus an island could be connected to multiple islands at any one time with a separate data transfer occurring simultaneously on each connection.

Upon boot-up, the host system may configure certain address registers within the Host Protocol island. These registers define to the ASIC the address range or ranges, within the memory map of the host system, through which the ASIC may be accessed. The system may also configure other rules concerning the protocol such as data transfer speed, bandwidth, whether the ASIC may initiate transfers on that interface and so forth. This protocol configuration can be a lengthy process, and as such is usually performed only once, at system start up. The process is not expected to be repeated unless there is an occurrence of a system-wide power-cycle or system-wide reset event. In systems, which must operate in a 24×7 (24-hours/day, 7 days/week) mode, these events are encountered extremely rarely otherwise user access to the system and its data may be severely compromised.

2. Discussion of the Prior Art

Predicated on the foregoing discussion, the host system may, at times, find itself in a situation where it needs to reset just the ASIC, but need not reset the rest of the host system, and may also wish to accomplish this reset function without cutting power to any part of the system. Furthermore, it may wish to reset all the islands within the ASIC with exception of the Host Protocol island. A reset of this latter island would be time-consuming, since all the register settings configured at power-up during the lengthy protocol configuration process would be lost and the whole process would have to be performed all over again.

However, a problem resides in that at the time the host system issues the reset command, the Host Protocol island may be connected (via the interconnect) to some other island within the ASIC and be performing a data transfer therewith. Resetting this other island, but not resetting the Host Protocol island, while the transfer is occurring may cause a deadlock. For example, internal interconnect protocols within ASIC's are typically device paced, in essence, the two islands connected in the data transfer each drive a READY signal to the other to indicate that it is ready to transfer some data. When both READY signals are asserted in a particular clock cycle then data is transferred. If one island is reset in mid-transfer it will de-assert its READY signal. The Host Protocol island, which is still active, may be asserting READY waiting for the other island to also assert READY. This READY will never come from the other island while it is undergoing reset and when it comes out of reset, it will have no memory that it was performing a data transfer. It will therefore not continue that transfer from where it left off. Thus the Host Protocol island will wait forever to receive a READY signal from the other island and a deadlock results.

A known solution to this problem is for the host system to issue a message via the ASIC to the processor, as represented in FIG. 1 of the drawings, and let the processor direct the necessary reset operations. This message typically comes in the form of a write to a “doorbell” register within the ASIC. A write to such a register causes the ASIC to assert an interrupt to the processor. On receipt of this interrupt, the processor resets islands which are not currently in data transfer with the Host Protocol island. To do this, the processor sends commands to a reset controller island within the ASIC, wherein there is represented the reset controller and how it is typically embedded in the ASIC. The controller has a port on the interconnect to allow it to receive commands from the processor via the Processor Protocol island and can drive a reset signal to each of the other islands as directed.

If the Host Protocol island is performing a data transfer to/from another ASIC island, then to avoid the deadlock, as described above, the processor must wait until the transfer has terminated before it can reset that other ASIC island. The processor may attempt to issue an abort command, to the islands concerned, in order to expedite transfer termination.

The drawback of this known solution is that it can be a lengthy process, inasmuch as the interrupt takes time to reach the processor. When it services the interrupt, the processor must determine which ASIC islands can be reset immediately without carrying a deadlock, and which islands it must wait for to finish their current data transfers. The processes may also issue abort commands; however, once an operation within the ASIC has started, the abort command could be ignored until that operation has reached a certain stage, such as at an architected predefined address boundary. The only exception can be where a transfer may stop anywhere is when an error has been detected, in which case the transfer stops immediately. Thus, the known solution has a lot of delay built into it, whereby if the process takes too long, the host system may decide that the ASIC is somehow stuck and that it needs to recover the situation by resetting the entire ASIC (Host Protocol island included) and repeat the lengthy configuration process that is normally only performed at boot up.

In addition, the known solution is processor intensive, since the processor must oversee each step of the reset process, from determining which islands can and cannot be reset immediately to issuing abort commands. Valuable CPU has to be spent directing the reset process, which could be better spent elsewhere more efficiently and economically.

### SUMMARY OF THE INVENTION

The present invention solves the problem by augmenting the ASIC's reset controller island to include Reset Imminent Warning (R/W) signals. The reset controller can drive one R/W signal to each of the other islands in the ASIC. The reset controller constantly monitors activity on the interconnect noting which islands are currently in data transfer with the Host Protocol island.

### BRIEF DESCRIPTION OF THE DRAWINGS

Reference may now be made to the following detailed description of the invention, taken in conjunction with the accompanying drawings, in which:

FIG. 1 illustrates a diagrammatic representation of an ASIC pursuant to the present state of the art;

FIG. 2 illustrates a diagrammatic representation of an ASIC incorporating a reset controller which includes resent imminent warning signal generating structure pursuant to the invention; and

FIG. 3 illustrates, generally schematically, an arrangement for determining interconnect protocol error signals.

### DETAILED DESCRIPTION OF THE INVENTION

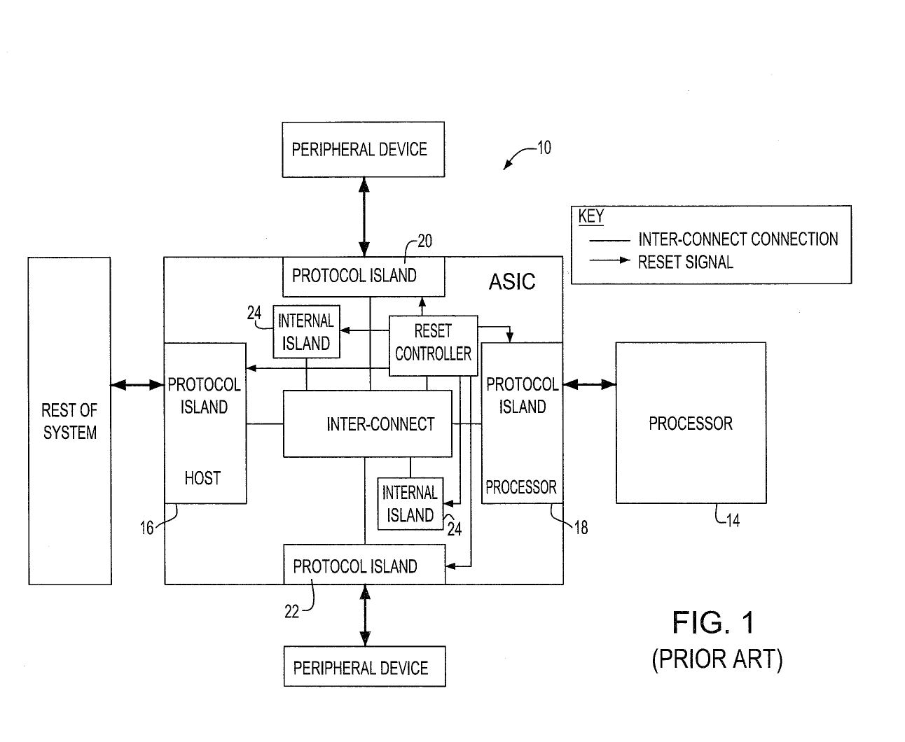

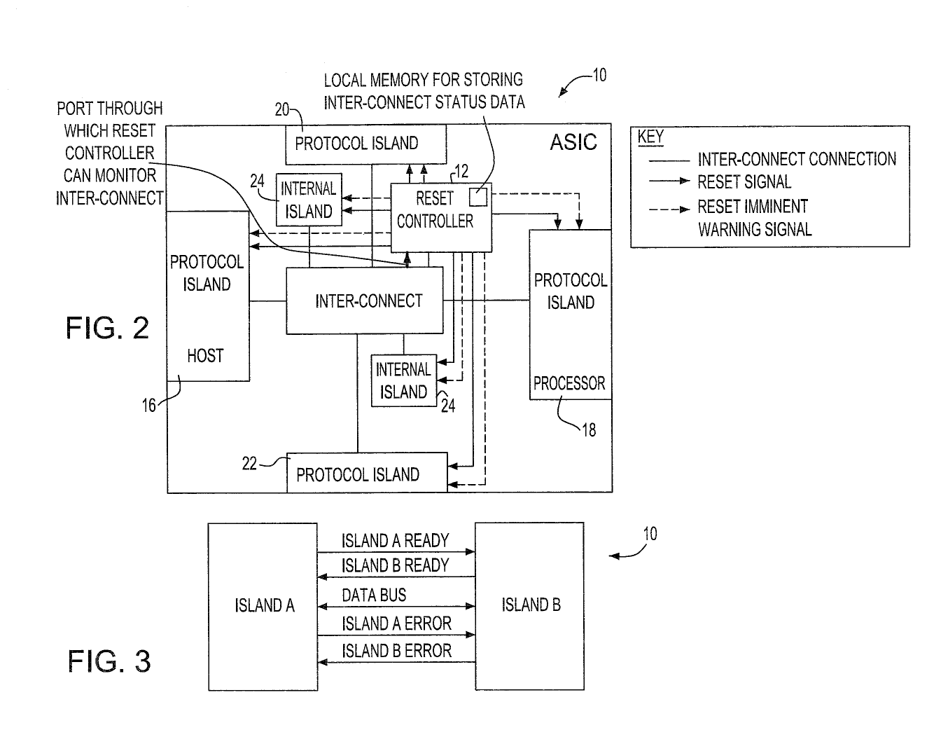

On receipt of a reset command from the host system, as shown in FIG. 2 of the drawings, an ASIC 10 sends an interrupt to the processor in the same way as before, informing it that a reset command was issued. However, in this instance, a reset controller 12, and not the processor 14 (as in FIG. 1), directly coordinates the reset of the ASIC. In fact the processor 14 need not take any action in the reset process. Any islands 16, 18, 20, 22, 24 not currently in data transfer with the Host Protocol island 16 are reset immediately. Any that are in data transfer, have their R/W signals asserted by the reset controller 12, as does the Host Protocol island 16. On receipt of an R/W, the islands break off the transaction immediately but in a way that will prevent deadlock. Once the transaction has terminated, the reset controller 12 issues resets to the island or islands that were previously in data transfer with the Host Protocol island.

The advantage of this invention is that it does not require a processor 14 to direct the reset process. Therefore it responds much quicker to the reset command from the host system and will complete the process much faster than the known solution. The processor can still be kept informed that a reset command has been issued (via the interrupt from the ASIC) but its resources can be used elsewhere and are no longer taken up by having to coordinate the reset process.

The reset controller 12 may have the following added thereto:
Reset Imminent Warning (R/W) signals—There is an R/W line going to each island from the reset controller 12. The reset controller can individually drive each R/W signal.
Interconnect monitor port—This allows the reset controller to determine which islands are currently in data transfer with the Host Protocol island and which are not.
Interconnect status memory—Information collected from the interconnect monitor port is stored in some local memory.

A reset command from the host system is then dealt with as follows:
1. The host system writes to the doorbell register in the ASIC to issue the reset command (as before). The interrupt to the processor is sent as before but the reset controller is also informed (via an internal signal, not shown). The interrupt to the processor is simply informational and the processor does not need to take any further action.
2. By accessing the local interconnect status information retained by the reset controller 12, the reset lines are driven to any islands not currently in data transfer with the Host Protocol island 16.
3. If there are any islands in data transfer with the Host Protocol island, their R/W signals are asserted. The R/W signal of the Host Protocol island is also asserted. The assertion of an R/W signal to an island means that it should terminate the interconnect transfer as soon as possible.
4. Data transfers to/from the Host Protocol island are terminated. In order to expedite the termination of a data transfer, the invention specifies the following behavior for an island when it receives an R/W: Internal interconnect protocols, such as Gray, et al., typically have a mechanism built into them which allows one side of the data transfer to signal that it has detected a problem with the transfer (e.g. a data parity error). This mechanism is typically an ERROR signal, which can be asserted by the slave island of the transfer, i.e., not the island that initiated the transfer in the first place (which would be known as the master island). When ERROR is asserted, the transfer must terminate on the next clock cycle.
5. Once all interconnect data transfers have ceased (as detected via the interconnect monitor port) the reset controller asserts the reset lines to all islands that were previously in data transfer with the Host Protocol island.

In an alternative embodiment of the invention, the behavior, as described in Step 4 hereinabove, could be as follows: The master island, on receipt of a R/W, indicates that the next data cycle for the transfer will be the last. Interconnect protocols typically have a mechanism to indicate this for instance by asserting a special “LAST DATA” signal to the slave, or in the case of the protocol described in Gray et al, it is by de-asserting a signal called ICREQ (See U.S. Pat. No. 6,467,001 for more details). Thus the data transfer is terminated on the next data cycle. Some protocols would mandate that transfers are not allowed to terminate unless the transfer has reached a certain address boundary. If this is so, then the master ends the transfer on the next boundary after receiving an R/W. This is not as efficient as the embodiment described in Step 4 but it is still an improvement over the known solution as the invention still responds quicker to the reset command from the host system.

A further enhancement to this invention would be for the reset controller to monitor Interconnect transfers involving not only the Host Protocol island but other protocols islands as well. Thus if one of the other protocol islands was in data transfer with some other island (which is not the Host Protocol island), a reset would not be issued to either of those islands immediately. Instead R/W's would be issued to allow data transfers between those two islands to cease cleanly. This enhancement would be used where some other external port on the ASIC is active when the reset command is issued to avoid a similar deadlock situation earlier described as happening on the Host Protocol island.

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but to fall within the spirit and scope of the appended claims.

What is claimed is:

1. A reset method for an application specific integrated circuit (ASIC), wherein said ASIC includes a plurality of integrally interconnected operative components to facilitate data transfer between said components, said method comprising:
providing a host protocol component for implementing an interface between said components and external ancillary devices and a processor;
said host protocol component being programmable to prevent a deadlock among said operative components during transfer of data necessitating resetting of said components; and
providing an ASIC reset controller for monitoring data transfer activities among said components and emitting rest imminent warning signals (R/W) to said respective operative components for resetting thereof to resultingly prevent operative deadlocks in said ASIC components.

2. A reset method as claimed in claim 1, wherein said reset process is implemented responsive to said reset imminent warning signals by said reset controller.

3. A reset method as claimed in claim 2, wherein said reset controller monitors interconnect data transfer to and from said host protocol component and further protocol components in said ASIC so as to prevent component deadlocks caused during data transfers necessitating resetting of said components.

4. An application specific integrated circuit (ASIC), wherein said ASIC includes a plurality of integrally interconnected operative components to facilitate data transfer between said components, comprising:
host protocol component for implementing an interface between said components and external ancillary devices and a processor, said host protocol component being programmable to prevent a deadlock among said operative components during transfer of data necessitating resetting of said components; and
an ASIC reset controller for monitoring data transfer activities among said components and emitting rest imminent warning signals (R/W) to said respective operative components for resetting thereof to resultingly prevent operative deadlocks in said ASIC components.

5. An arrangement as claimed in claim 4, wherein said reset controller implement said resetting responsive to said reset imminent warning signals.

6. A n arrangement as claimed in claim 5, wherein said reset controller monitors interconnect data transfer to and from said host protocol component and further protocol components in said ASIC so as to prevent component deadlocks caused during data transfers necessitating resetting of said components.
